(19) United States
(12) Patent Application Publication
(10) Pub. No.: US 2014/0362024 A1
(43) Pub. Date: Dec. 11, 2014

(54) ACTIVATING VOICE COMMAND FUNCTIONALITY FROM A STYLUS

(71) Applicant: barnesandnoble.com llc, New York, NY (US)

(72) Inventor: Kourtny M. Hicks, Sunnyvale, CA (US)

(21) Appl. No.: 13/912,793

(22) Filed: Jun. 7, 2013

(51) Int. Cl. G06F 3/0354; G06F 3/16; G06F 3/044

(52) U.S. Cl. CPC G06F 3/03545; G06F 3/044; G06F 3/167
USPC 345/174

(57) ABSTRACT

Techniques are disclosed for activating voice command functionality from a stylus. The voice commands may include initiating searches for user content or sending messages, for example. In some instances, the voice command stylus may include at least one control feature that can be used to activate voice command functionality and a microphone for receiving stated voice commands. Once the voice command is received, the stylus may transmit the voice command to a related electronic touch sensitive device (e.g., a smart phone, tablet, or eReader) and/or to a remote system (e.g., a cloud computing server). The related device and/or the remote system may then determine and/or execute a desired function based on the voice command. For example, if the voice command initiated a search for lecture notes taken on a certain date, execution of the voice command may cause those lecture notes to be displayed on the related device.

### FIELD OF THE DISCLOSURE

This disclosure relates to styluses for computing devices, and more particularly, to activating voice command functionality from a stylus.

### BACKGROUND

Electronic computing devices such as tablets, eReaders, mobile phones, smart phones, personal digital assistants (PDAs), and other such devices are commonly used for providing digital content. The content may be, for example, an e-book, an online website, images, documents, notes, lectures, presentations, audio content, or video content, just to name a few types. Such devices sometimes use or include a touch sensitive display, which is useful for displaying a user interface that allows a user to interact with the digital content. The user may interact with the electronic touch sensitive device using fingers and/or a stylus, for example. The use of a stylus may enhance the user's experience when interacting with the touch sensitive device. For example, using a stylus may increase the user's input accuracy or comfort, especially when writing or drawing on the surface of the device.

### BRIEF DESCRIPTION OF THE DRAWINGS

FIGS. 1a-b illustrate an example electronic touch sensitive device capable of being used with a stylus having voice command functionality, in accordance with an embodiment of the present invention.

FIG. 1c illustrates an example voice command stylus for use with an electronic touch sensitive device, in accordance with an embodiment of the present invention.

FIGS. 1d-e illustrate example configuration screen shots of the electronic touch sensitive device shown in FIGS. 1a-b, configured in accordance with an embodiment of the present invention.

FIG. 2a illustrates a block diagram of an electronic touch sensitive device, configured in accordance with an embodiment of the present invention.

FIG. 2b illustrates a block diagram of an example voice command stylus for use with an electronic touch sensitive device, configured in accordance with an embodiment of the present invention.

FIG. 2c illustrates a block diagram of a communication system including the electronic touch sensitive device of FIG. 2a, the voice command stylus of FIG. 2b, and a cloud computing server, in accordance with one or more embodiments of the present invention.

FIGS. 3a-e′ illustrate examples of activating a voice command from a stylus to initiate a search for user content, in accordance with one or more embodiments of the present invention.

FIGS. 4a-b illustrate an example of activating a voice command from a stylus to send a message to another device, in accordance with an embodiment of the present invention.

FIG. 5 illustrates a method for implementing stylus voice command functionality, in accordance with one or more embodiments of the present invention.

### DETAILED DESCRIPTION

Techniques are disclosed for activating voice command functionality from a stylus. The voice commands may include initiating searches for user content or sending messages, for example. In some instances, the voice command stylus may include at least one control feature that can be used to activate voice command functionality and a microphone for receiving stated voice commands. Once the voice command is received, the stylus may transmit the voice command to a related electronic touch sensitive device (e.g., a smart phone, tablet, or eReader) and/or to a remote system (e.g., a cloud computing server). The related device and/or the remote system may then determine and/or execute a desired function based on the voice command. For example, if the voice command initiated a search for lecture notes taken on a certain date, execution of the voice command may cause those lecture notes to be displayed on the related device. Numerous variations and configurations will be apparent in light of this disclosure.

General Overview

As previously explained, electronic touch sensitive devices such as tablets, eReaders, smart phones, etc., are commonly used for displaying user interfaces and consumable content. As was also explained, users may desire to interact with the device using a stylus or other implement to increase the user's input accuracy or comfort, for example. In general, the stylus may be used as an alternative implement to the user's finger when interacting with the user interface (UI) of a touch sensitive computing device. In some instances, a user may desire to state commands rather than issuing them in some other form (e.g., typing out the command, navigating through various menus, etc.).

Thus and in accordance with one or more embodiments of the present invention, techniques are provided for activating voice command functionality from a stylus intended to be used with an electronic touch sensitive device. A stylus having the ability to activate voice command functionality from the stylus itself is generally referred to herein as a “voice command stylus.” The voice commands may include initiating searches for user content on a device, initiating searches for content on the web, sending voice messages, sending voice to text messages (e.g., where the voice message is translated to a text message), opening or closing applications, initiating calls, controlling media playback, creating calendar events, or navigating the user interface of a related electronic touch sensitive device, just to name a few examples. In some embodiments, the voice command stylus may include at least one control feature (e.g., a side button) to activate voice command functionality, a microphone for receiving stated voice commands, and a communication module for transmitting received voice commands. The voice commands may be transmitted to a related electronic touch sensitive device via a wired or wireless communication link (e.g., via Bluetooth or Wi-Fi), or to a remote system (e.g., a cloud computing server). Voice commands may be transmitted to the remote system directly (e.g., via Wi-Fi or a cellular network) or indirectly (e.g., through a related electronic touch sensitive device). The intelligence (e.g., the processor(s)/controller(s), memory, software, etc.) for determining and/or executing functions based on received voice commands may be located in the stylus itself, in a related touch sensitive computing device, in a remote computing system, or some combination thereof.

As previously described, the voice command stylus may be used to activate numerous different voice commands. In an example application, the voice command stylus may be used to initiate a search for user content on a related touch sensitive computing device or a remote system. In one such example application, the user may activate voice command functionality using a stylus control feature, such as by pressing a side button on the stylus. In some instances, the stylus may prompt the user to indicate that it is ready to receive a voice command, such as by playing the phrase “please state a command” (in embodiments of the stylus that include a speaker) or by flashing a light (in embodiment of the stylus that include a light source), for example. The user can then state a voice command to initiate the search. For example, if the user is searching for school notes for a particular class from a particular date, the user may state “find, Bio 120A notes, from yesterday.” Depending upon the configuration of the voice command stylus, the issued voice command (the stated search) may be sent to a related device and/or to the remote system, as will be discussed in turn. Voice command software (e.g., Google Now, Apple's Siri, or Samsung's S Voice) may then be used to determine and/or execute the desired function based on the issued voice command. In this specific example, the function may cause the user's Bio 120A notes from yesterday to be displayed on the related electronic touch sensitive device.

In another example application, the voice command stylus may be used to send a message to an unrelated device, such as another stylus. Again, the user can activate the voice command functionality using a stylus control feature, such as pressing a side button on the stylus, for example. The user can then state a voice command to send a voice message to another stylus. For example, if the user is sending a message to a friend's stylus—e.g., Tom's stylus—asking him to pick up some pizza for a study group session they plan on having that night, the user may state “message to Tom, hi Tom . . . can you please get a pizza for study group tonight?” Again, depending upon the configuration of the voice command stylus, the issued voice command (the stated message) may be transmitted from the stylus to a related electronic touch sensitive device and/or to the remote system. Voice command software may then be used to determine and/or execute a desired function based on the issued voice command. In this specific example, the function can cause the stated message to be sent to Tom's stylus. In some instances, the message may be sent as a voice message, while in other instances, it may be converted to a text message before sending it to Tom's stylus, depending upon the configuration of the stylus voice command functionality.

In general, a stylus as described herein is any implement that is configured to interact with a touch sensitive surface/interface of a computing device. Stylus interaction may include direct contact (e.g., via a capacitive or resistive touch surface), proximate contact (e.g., via hovering input using electro-magnetic resonance technology), or other suitable interaction with an electronic touch sensitive device. The form factor of the stylus may be pen-like having an elongated body portion and a stylus tip used to interact with an electronic touch sensitive device, but need not be so limited. In some embodiments, the voice command stylus may include componentry that may be used to assist with voice command functionality, such as a speaker, a display, a vibrating motor, and/or other suitable componentry, as will be discussed in turn. For example, in an embodiment of the voice command stylus including a speaker, a prompt may be played after activating voice command functionality, as was previously described. Numerous variations and configurations will be apparent in light of this disclosure.

Device and Stylus Examples

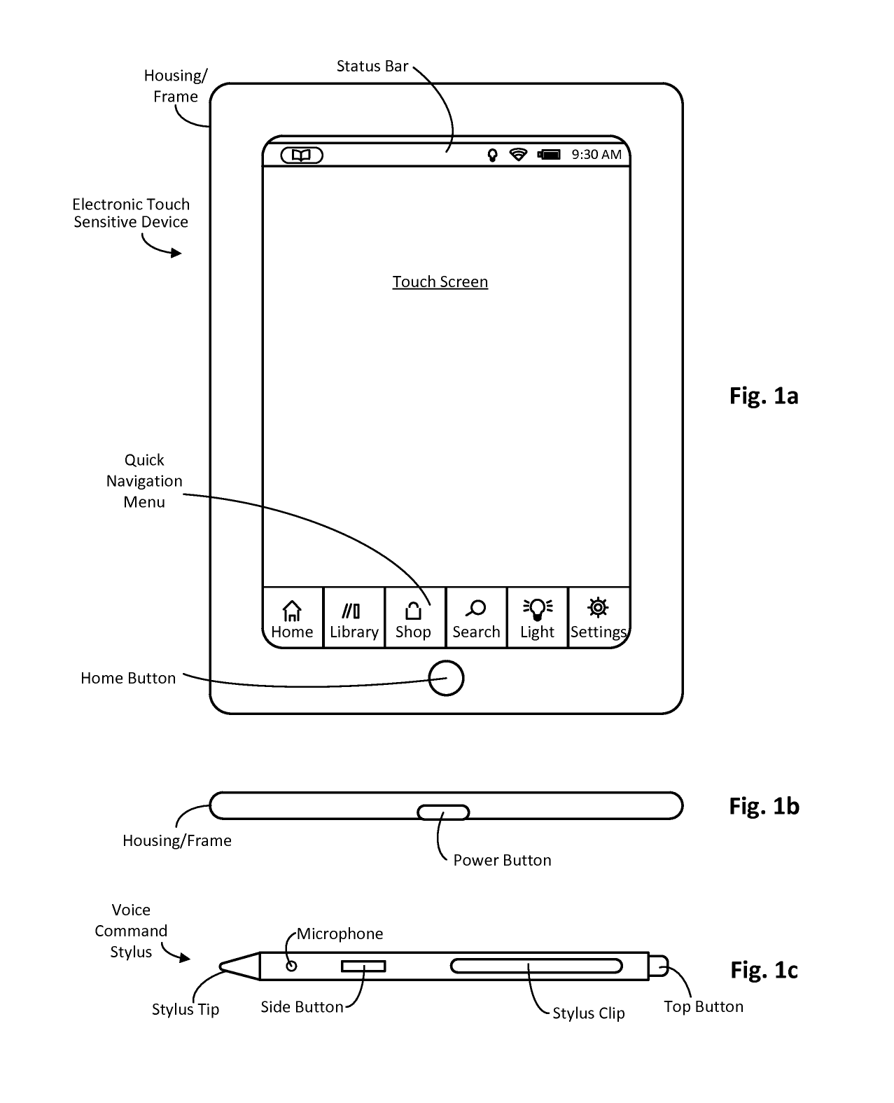

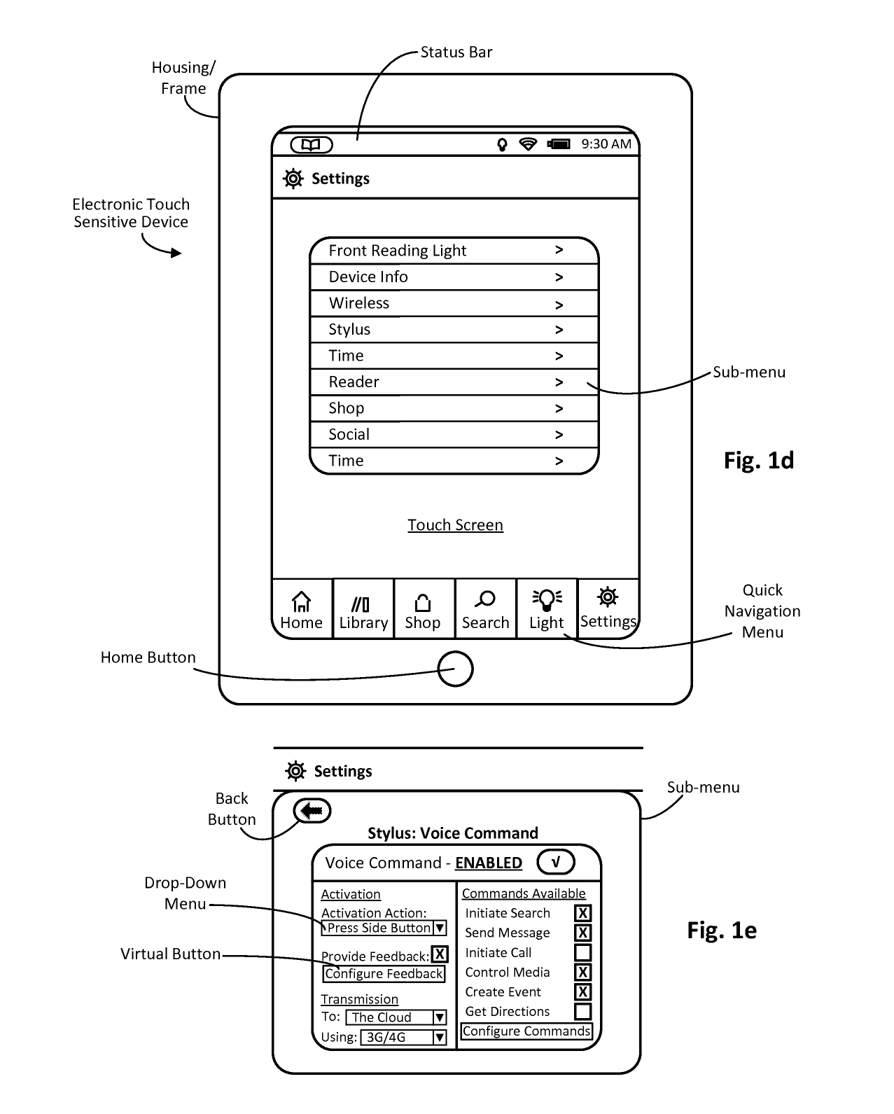

FIGS. 1a-b illustrate an example electronic touch sensitive device capable of being used with a stylus having voice command functionality, in accordance with an embodiment of the present invention. The device could be, for example, a tablet such as the NOOK® tablet or eReader by Barnes & Noble. In a more general sense, the device may be any electronic device having a touch sensitive user interface. The device may also have capability for displaying content to a user, such as a mobile phone or mobile computing device such as a laptop, a desktop computing system (with a built-in or separate monitor), a television, a smart display screen, or any other device having a touch screen display or a non-touch display screen that can be used in conjunction with a touch sensitive surface. In a more general sense, the touch sensitive device may comprise of any device capable of receiving voice commands from a related stylus as described herein. As will be appreciated, the claimed invention is not intended to be limited to any particular kind or type of electronic touch sensitive device.

As can be seen with the example configuration shown in FIGS. 1a-b, the device comprises a housing that includes a number of hardware features such as a power button and a press-button (sometimes called a home button herein). A touch screen based user interface is also provided, which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other touch sensitive devices may have fewer or additional such user interface (UI) touch screen features, or different UI touch screen features altogether, depending on the target application of the device. Any such general UI controls and features can be implemented using any suitable conventional or custom technology, as will be appreciated.

The power button can be used to turn the device on and off, and may be used in conjunction with a touch-based UI control feature that allows the user to confirm a given power transition action request (e.g., such as a slide bar or tap point graphic to turn power off). In this example configuration, the home button is a physical press-button that can be used, for example, to display the quick navigation menu, which is a toolbar that provides quick access to various features of the device. The button may also control other functionality. For instance, holding the home button down in a push-and-hold fashion could initiate a searching-for-stylus function to relate a voice command stylus to the device (e.g., to pair the stylus and device together when using Bluetooth technology). Holding the button down in a push-and-hold fashion could also activate voice command functionality from a related voice command stylus, allowing a user to state a command to the stylus after the home button is held.

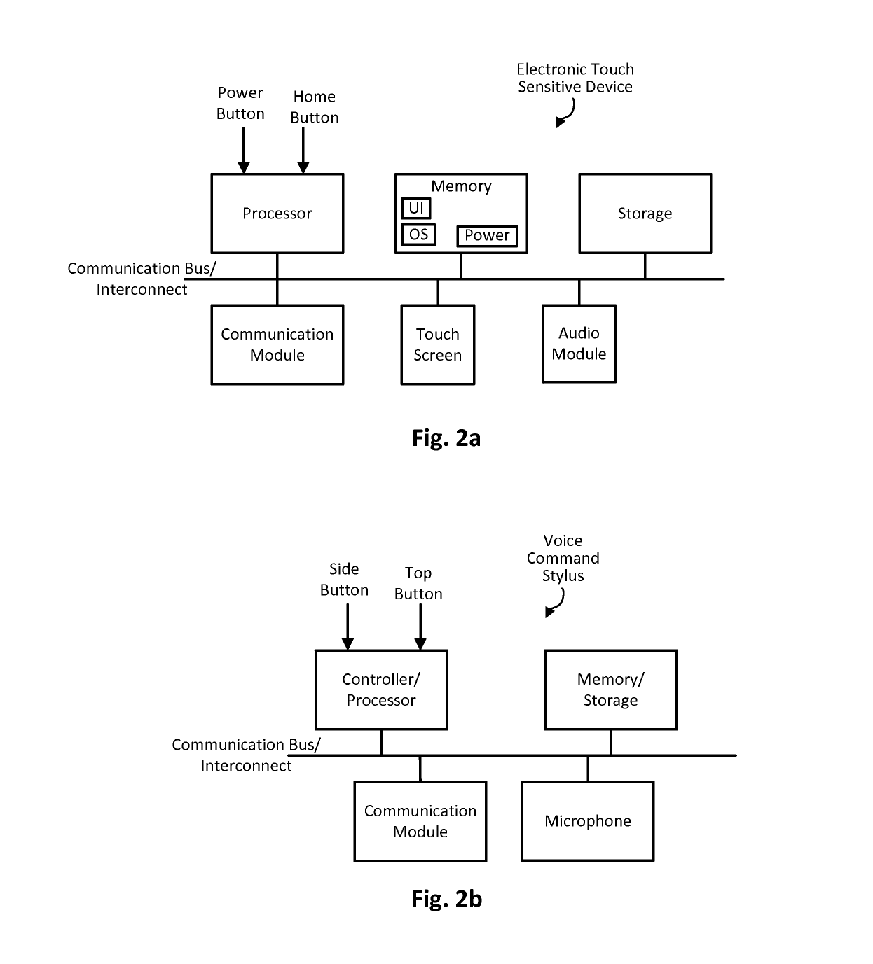

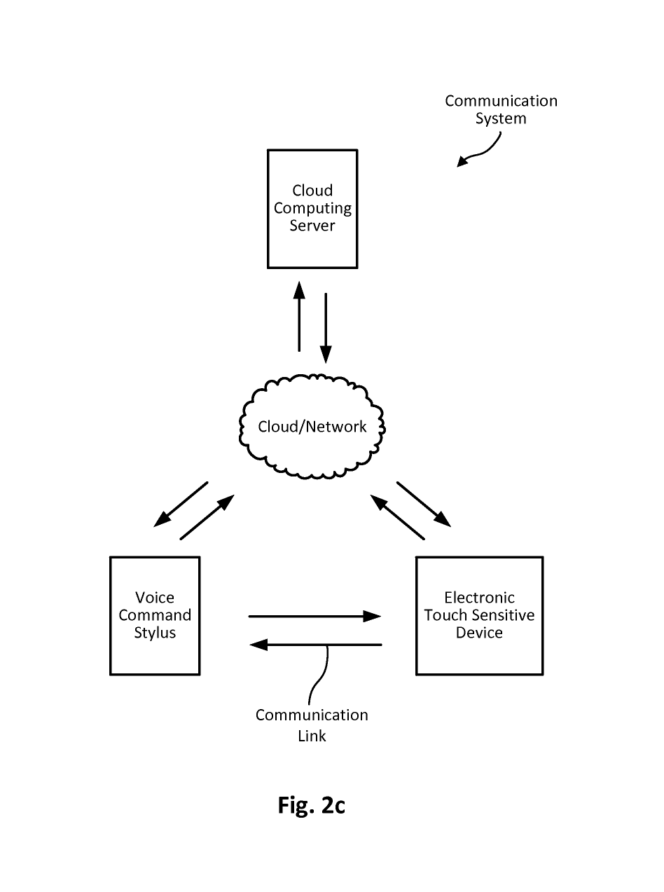

FIG. 1c illustrates an example voice command stylus for use with an electronic touch sensitive device, in accordance with an embodiment of the present invention. As can be seen, in this particular example, the stylus includes a stylus tip used to interact with a touch sensitive device, e.g., through direct or proximate contact (e.g., by hovering over the device). In this example, the stylus tip has a triangular shape, while in other examples, the stylus tip may be more rounded, or any other suitable shape. The stylus tip may be made of any number of materials of different textures and firmness depending on the needs of the specific touch sensitive device. This example stylus configuration also includes a side button along the shaft of the stylus and a top button on the end opposite the stylus tip. The example voice command stylus in FIG. 1c is shown having a top and side button. However, the stylus may include fewer or additional control features or different control features altogether. The control features may be used to activate voice command functionality from the stylus or provide other input related to voice command functionality, as will be apparent in light of this disclosure. For example, the side button may be used to activate voice command functionality from the stylus. The example voice command stylus shown in FIG. 1c also includes a microphone and a stylus clip (which can be used to secure the stylus to various objects). As previously described, the microphone on the voice command stylus may be used to receive stated voice commands. Example details of the architecture of a voice command stylus in accordance with one or more embodiments will be discussed in turn with reference to FIG. 2b

In some embodiments, the voice command stylus may include other componentry to assist with the voice command functionality. For example, the stylus may include a vibrating motor for indicating that voice command functionality has been activated, a multi-colored light-emitting diode (LED) to indicate the status of an issued voice command (e.g., it turns red after a voice command is issued and then turns green after the voice command is executed), or a display (e.g., an LED display) to provide feedback after a voice command has been executed, just to name a few examples. Numerous variations and configurations of a voice command stylus will be apparent in light of this disclosure.

FIGS. 1d-e illustrate example configuration screen shots of the electronic touch sensitive device shown in FIGS. 1a-b, configured in accordance with an embodiment of the present invention. In one particular embodiment, a Stylus Voice Command configuration sub-menu, such as the one shown in FIG. 1e, may be accessed by tapping or otherwise selecting the Settings option in the quick navigation menu, which causes the device to display the general sub-menu shown in FIG. 1d. From this general sub-menu the user can select any one of a number of options, including one designated Stylus in this specific example case. Selecting this sub-menu item (with an appropriately placed screen tap) may cause the Stylus Voice Command configuration sub-menu of FIG. 1e to be displayed, in accordance with an embodiment. In other example embodiments, selecting the Stylus option may present the user with a number of additional sub-options, one of which may include a so-called Voice Command option, which may then be selected by the user so as to cause the Stylus Voice Command configuration sub-menu of FIG. 1e to be displayed. Any number of such menu schemes and nested hierarchies can be used, as will be appreciated in light of this disclosure. Note that other embodiments need not be user-configurable and may just have hard-coded functionality. The degree of hard-coding versus user-configurability can vary from one embodiment to the next, and the claimed invention is not intended to be limited to any particular configuration scheme of any kind.

As will be appreciated, the various UI control features and sub-menus displayed to the user are implemented as UI touch screen controls in this example embodiment. Such UI touch screen controls can be programmed or otherwise configured using any number of conventional or custom technologies. In general, the touch screen translates the user touch in a given location into an electrical signal which is then received and processed by the underlying operating system (OS) and circuitry (processor, etc.). The user touch may be performed with a finger, a stylus, or any other suitable implement, unless otherwise specified. Additional example details of the underlying OS and circuitry in accordance with one or more embodiments will be discussed in turn with reference to FIG. 2a.

As previously explained, and with further reference to FIGS. 1d and 1e, once the Settings sub-menu is displayed (FIG. 1d), the user can then select the Stylus option. In response to such a selection, the Stylus Voice Command configuration sub-menu shown in FIG. 1e can be provided to the user. The user can configure a number of options with respect to the stylus voice command functionality, in this example embodiment. For instance, in this example case, the configuration sub-menu includes a UI check box that when checked or otherwise selected by the user, effectively enables the stylus voice command functionality (shown in the enabled state); unchecking the box may disable the ability to activate voice commands from the stylus. Other embodiments may have the stylus voice command functionality always enabled, for example. The configuration settings described herein are provided for illustrative purposes and are not intended to limit the options or features related to stylus voice command functionality.

The example Stylus Voice Command settings screen shown in FIG. 1e includes an Activation section that allows the user to set how voice command functionality is activated. As shown, Press Side Button has been selected as the Activation Action from the corresponding drop-down menu. In this configuration, when the side button on the stylus (such as the stylus shown in FIG. 1c) is pressed, the microphone is enabled to allow a user to state a voice command to the stylus. Other options for activating voice command functionality may include pressing another button (e.g., a top button), twisting a rotatable knob, or moving a sliding control feature, based on the configuration of the stylus. In some embodiments, the microphone may be unidirectional and always enabled so that it always receives voice commands when they are issued from the right perspective (relative to the microphone). In some such embodiments, the stylus voice command functionality may always be activated and ready to receive voice commands from a user. The next setting in the Activation section allows the user to determine if the stylus should Provide Feedback (shown enabled to provide feedback). The activation feedback may be used to notify the user that a voice command can be stated, e.g., that voice command functionality has been activated. The feedback may be visual (e.g., visual indication from an LED on the stylus or from a stylus display), auditory (e.g., a beep or prompt from a speaker on the stylus), and/or tactile (e.g., a vibration from the stylus). When enabled, the user can configure the feedback provided using the Configure Feedback virtual button.

The example Stylus Voice Command settings screen shown in FIG. 1e also includes a Transmission section that allows the user to set how issued voice commands are transmitted. As shown, The Cloud has been selected as the location that the voice commands are transmitted (using the corresponding drop-down menu). In this configuration, issued voice commands are transmitted or sent to a remote system (e.g., to a cloud computing server) to determine and/or execute a desired function based on the issued voice command. The drop-down menu may include other location options where issued voice commands could be transmitted or sent, such as a related electronic touch sensitive device (e.g., a smart phone, tablet, or eReader). In some embodiments, issued voice commands may be sent to more than one location, such as both a related electronic touch sensitive device and a remote system. The next setting in the Transmission section allows the user to determine how issued voice commands are transmitted, e.g., what wireless technology they are transmitted over. As shown, 3G/4G has been selected (from the Using drop-down menu) indicating that the voice commands will be sent over a cellular connection. The available wireless technologies for transmitting issued voice commands may depend upon the particular configuration of the voice command stylus and/or a related electronic touch sensitive device. For example, as previously described, when sending issued voice commands to the remote system, they may be sent indirectly through a related electronic touch sensitive device. Wireless technologies used to transmit issued voice commands may include cellular technologies (e.g., 3G/4G), Bluetooth, Wi-Fi, or any other suitable wireless technology.

The example Stylus Voice Command settings screen shown in FIG. 1e also includes a Commands Available section that allows the user to select the commands available to the user. In this example embodiment, the user is able to select from a list of commands and configure the voice command functionality accordingly. However, in other embodiments, the voice commands available may be hard-coded, may depend upon the voice command software involved, and/or may depend upon the related touch sensitive device being used. Continuing with the example settings screen shot in FIG. 1e, the Commands Available include: Initiate Search, which may allow a user to search for content from a related device or a remote system; Send Message, which may allow a user to send a voice or voice to text message to an unrelated device (e.g., another stylus); Initiate Call, which may allow a user to initiate a call with one of the user's contacts or based on a stated number; Control Media, which may allow a user to issue media control commands (e.g., play, pause, etc.); Create Event, which may allow a user to create a calendar event; and Get Directions, which may allow a user to ask for directions from one location to another. In this example, each voice command has a box next to it to allow a user to select which commands are available. After selecting which commands the user wants to have available, the user may be able to further configure the commands using the Configure Commands virtual button. For example, the user may be able to set trigger words for each voice command, such as “search” for the Initiate Search command and “call” for the Initiate Call command. Numerous other configurable aspects will be apparent in light of this disclosure.

As can be further seen, a back button arrow UI control feature may be provisioned on the touch screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired. Again, while FIGS. 1d and 1e show user configurability, other embodiments may not allow for any such configuration, wherein the various features provided are hard-coded or otherwise provisioned by default.

Architecture

FIG. 2a illustrates a block diagram of an electronic touch sensitive device, configured in accordance with an embodiment of the present invention. As can be seen, this example device includes a processor, memory (e.g., RAM and/or ROM for processor workspace and storage), additional storage/memory (e.g., for content), a communications module, a touch screen, and an audio module. A communications bus and interconnect is also provided to allow inter-device communication. Other typical componentry and functionality not reflected in the block diagram will be apparent (e.g., battery, co-processor, etc.). Further note that although a touch screen display is provided, other embodiments may include a non-touch screen and a touch sensitive surface such as a track pad, or a touch sensitive housing configured with one or more acoustic sensors, etc. In any such cases, the touch sensitive surface is generally capable of translating a user's contact with the surface (whether direct or proximate, as previously described) into an electronic signal that can be manipulated or otherwise used to trigger a specific user interface action, such as those provided herein. The principles provided herein equally apply to any such touch sensitive devices. For ease of description, examples are provided with touch screen technology.

The touch sensitive interface (touch sensitive display or touch screen in this example) can be any device that is configured with user input detecting technologies, whether capacitive, resistive, acoustic, active or passive stylus, and/or other input detecting technology. The screen display can be layered above input sensors, such as a capacitive sensor grid for passive touch-based input (such as with a finger or passive stylus in the case of a so-called in-plane switching (IPS) panel), or an electro-magnetic resonance (EMR) sensor grid (e.g., for sensing a resonant circuit of the stylus). In some embodiments, the touch screen display can be configured with a purely capacitive sensor, while in other embodiments the touch screen display may be configured to provide a hybrid mode that allows for both capacitive input and EMR input. In still other embodiments, the touch screen display is configured with only an active stylus sensor. In any such embodiments, a touch screen controller may be configured to selectively scan the touch screen display and/or selectively report contacts detected directly on or otherwise sufficiently proximate to (e.g., within a few centimeters) the touch screen display. Numerous touch screen display configurations can be implemented using any number of known or proprietary screen based input detecting technology.

In one example embodiment, stylus interaction can be provided by, for example, placing the stylus tip on the stylus detection surface, or sufficiently close to the surface (e.g., hovering one to a few centimeters above the surface, or even farther, depending on the sensing technology deployed in the stylus detection surface) but nonetheless triggering a response at the device just as if direct contact were provided on a touch screen display. As will be appreciated in light of this disclosure, voice command styluses as used herein may be implemented with any number of stylus technologies, such as the technology used in DuoSense® pens by N-trig® (e.g., wherein the stylus utilizes a touch sensor grid of a touch screen display) or EMR-based pens by Wacom technology, or any other commercially available or proprietary stylus technology. Further recall that the stylus sensor in the computing device may be distinct from an also provisioned touch sensor grid in the computing device. Having the touch sensor grid separate from the stylus sensor grid may allow the device to, for example, only scan for a stylus input, a touch contact, or to scan specific areas for specific input sources, in accordance with some embodiments. In one such embodiment, the stylus sensor grid includes a network of antenna coils that create a magnetic field which powers a resonant circuit within the stylus. In such an example, the stylus may be powered by energy from the antenna coils in the device and the stylus may return the magnetic signal back to the device, thus communicating the stylus' location, control feature inputs, etc.

Continuing with the example embodiment shown in FIG. 2a, the memory includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C, C++, objective C, JavaScript, custom or proprietary instruction sets, etc.), and encoded on a machine readable medium, that when executed by the processor (and/or co-processors), carries out the functionality of the device including stylus voice command functionality as described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The memory may also include voice command software used to determine and/or execute desired functions based on issued voice commands received from a stylus having voice command functionality. The voice command software may be implemented with any conventional or customary voice command technology, but in some example embodiments, the voice command software is implemented using Google Now, Microsoft's Speech, Apple's Siri, or Samsung's S Voice. In some instances, the voice command software may include separate speech recognition software (e.g., Nuance's Dragon software) to help determine what the issued voice command was. As previously described, voice command software used to determine and/or execute a desired function based on an issued voice command from a voice command stylus may located in the stylus itself, in a related electronic touch sensitive device, in a remote system, or in some combination thereof.

The processor can be any suitable processor (e.g., Texas Instruments OMAP4, dual-core ARM Cortex-A9, 1.5 GHz), and may include one or more co-processors or controllers to assist in device control. In this example case, the processor receives input from the user, including input from or otherwise derived from the power button and the home button of the device and input from or otherwise derived from the stylus, including input relating to stylus voice command functionality. The processor can also have a direct connection to a battery so that it can perform base level tasks even during sleep or low power modes, such as some or all of the voice command functionality described herein. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage (e.g., for storing consumable content and user files) can also be implemented with any suitable memory and size (e.g., 2 GBytes of flash memory). The display can be implemented, for example, with a 7 to 9 inch 1920×1280 IPS LCD touchscreen touch screen, or any other suitable display and touch screen interface technology.

The communications module can be configured to execute, for instance, any suitable protocol which allows for connection to a related stylus and/or to a remote system to facilitate the stylus voice command functionality as variously described herein. Example communication modules may include Bluetooth, 802.11b/g/n WLAN (Wi-Fi), cellular radio chip (3G/4G), or other suitable chip or chip set (including any custom or proprietary protocols). The communication module(s) may be used to transfer data to and from a voice command stylus, such as to receive voice commands, for example. The communication module(s) may also be used to transfer data to and from a remote system (e.g., a cloud computing server), such as to receive search results from the remote system based on a search activated from the voice command stylus, for example. In some specific example embodiments, the device housing that contains all the various componentry measures about 7″ to 9″ high by about 5″ to 6″ wide by about 0.5″ thick, and weighs about 7 to 8 ounces. Any number of suitable form factors can be used, depending on the target application (e.g., laptop, desktop, mobile phone, etc.). The device may be smaller, for example, for smart phone, eReader, and tablet applications and larger for smart computer monitor applications.

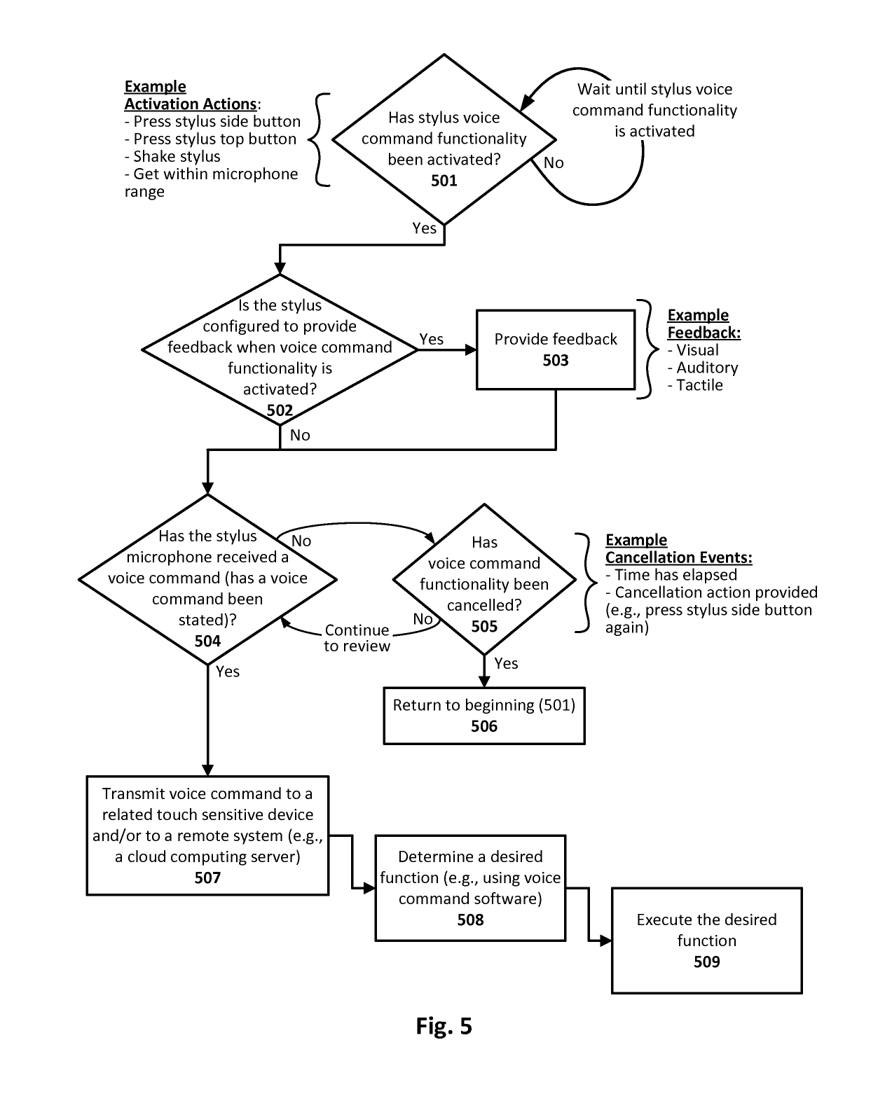

The operating system (OS) module can be implemented with any suitable OS, but in some example embodiments is implemented with Google Android OS or Linux OS or Microsoft OS or Apple OS. As will be appreciated in light of this disclosure, the techniques provided herein can be implemented on any such platforms. The power management (Power) module can be configured, for example, to automatically transition the device to a low power consumption or sleep mode after a period of non-use. The user interface (UI) module can be, for example, based on touch screen technology and the various example screen shots and use-case scenarios demonstrated in FIGS. 1a, 1d-e, and 3a-e′, along with the stylus voice command methodologies shown in FIG. 5.

The audio module can be configured, for example, to speak or otherwise aurally present information related to issued voice commands or other virtual content, if preferred by the user. Numerous commercially available text-to-speech modules can be used to facilitate the aural presentation of the information, such as Verbose text-to-speech software by NCH Software. In some example cases, if additional space is desired, for example, to store data used to determine and/or execute voice commands received from a stylus as described herein or other content, storage can be expanded via a microSD card or other suitable memory expansion technology (e.g., 32 GBytes, or higher). Further note that although a touch screen display is provided, other embodiments may include a non-touch screen and a touch sensitive surface such as a track pad, or a touch sensitive housing configured with one or more acoustic sensors, etc.

FIG. 2b illustrates a block diagram of an example voice command stylus for use with an electronic touch sensitive device, configured in accordance with an embodiment of the present invention. As can be seen, this example stylus includes a communication module, a microphone, a side button, and a top button. A communications bus and interconnect may be provided to allow inter-device communication. A controller and/or processor may be included in the stylus to activate voice command functionality, receive voice commands stated into the microphone, and then to transmit the voice commands to a related touch sensitive device and/or to a remote system, as will be apparent in light of this disclosure. When included, the processor may be any suitable processor and can be programmed or otherwise configured to assist in controlling the stylus. In some embodiments, the processor/controller may receive input from the user from control features, such as the side and top buttons of the voice command stylus. In some embodiments, the controller/processor may provide local intelligence to perform other functionality. Memory and/or storage may also be included in the stylus, for example, for storing data related to voice command functionality. The memory/storage may be implemented with any suitable memory and size (e.g., 2 to 4 GBytes of flash memory). Other componentry and functionality not reflected in the block diagram will be apparent (e.g., battery, antenna, etc.).

The microphone of the voice command stylus shown in FIG. 2b may be any suitable microphone used to receive voice commands stated by a user. In some embodiments, the microphone may be an acoustic-to-electric transducer/sensor that converts sound into an electrical signal. In some such embodiments, when voice commands are stated after voice command functionality is activated (e.g., by pressing a side button on the stylus), the voice command may be converted to an electrical signal. Any conventional or customary microphone or sound detecting technology may be used in the stylus to receive voice commands and convert stated voice commands into electrical signals. Once a voice command has been converted into an electrical signal, the communication module can be used to transmit the voice command to a related touch sensitive device or to a remote system. The example voice command stylus in FIG. 2b is shown having a side button and a top button. However, in some embodiments, the voice command stylus may have additional or different control features that may be used to activate voice command functionality from the stylus, for example.

The communication module may be configured to execute, for instance, any suitable protocol which allows for connection to a related touch sensitive device and/or to a remote system (e.g., a cloud computing serve). Example communication modules may include Bluetooth, 802.11b/g/n WLAN (Wi-Fi), cellular radio chip (3G/4G), or other suitable chip or chip set (including any custom or proprietary protocols). Therefore, the communication module may be used to transmit received voice commands via a Bluetooth connection, Wi-Fi connection, cellular network connection, or any other suitable wireless connection. In some embodiments, the communication module may be configured to receive data from a related touch sensitive computing device and/or a remote system, such as the results of a search initiated using the stylus. In some such embodiments, the communication module may be a transceiver that can both transmit and receive data, including data relating to voice command functionality. Numerous variations and configurations will be apparent in light of this disclosure.

Communication System

FIG. 2c illustrates a block diagram of a communication system including the electronic touch sensitive device of FIG. 2a, the voice command stylus of FIG. 2b, and a cloud computing server, in accordance with one or more embodiments of the present invention. The diagram in FIG. 2c shows possible communication links that may be used to implement voice command functionality as described herein. These include a communication link between the stylus and the device, a communication link between the stylus and the cloud computing server, and a communication link between the device and the cloud computing server. Although all of these communication link options are shown in FIG. 2c for ease of description, in some embodiments, one or more of the communication links need not be available to implement stylus voice command functionality, as will be apparent in light of this disclosure.

As shown in FIG. 2c, the voice command stylus and the related electronic touch sensitive device may be in communication via a communication link to execute one or more portions of the stylus voice command functionality as described herein. In this example embodiment, the electronic touch sensitive device may be, for example, an eReader, a smart phone, a laptop, a tablet, a desktop computer, or any other suitable electronic touch sensitive computing device. The communication link between the stylus and related device may be wired or wireless (e.g., using Bluetooth or Wi-Fi connections) and may allow for one way or two way communication between the stylus and the related device to transfer data, such as data relating to stylus voice command functionality. Conventional or custom discovery and handshake protocols can be used to introduce or otherwise relate a given voice command stylus with a given touch sensitive device, in accordance with some embodiments, prior to initiating the communication link shown in FIG. 2c or the stylus voice command functionality described herein. In some cases, the stylus may have identification information (e.g., a serial number) pertaining to the electronic touch sensitive device, or vice versa, to allow the stylus and the electronic touch sensitive to be related in some manner. For example, the stylus and device may be paired together to allow for communication between the stylus and the related device via a Bluetooth wireless connection. In some cases, the stylus and device may be related based on location or proximity, such that a given voice command stylus is related to the closest electronic touch sensitive device (e.g., the closest tablet). In any such cases, a software driver may come with the stylus and be loaded onto the target electronic device, so as to enable the communication between the device and stylus as well as the functionality described herein.

FIG. 2c also shows that the voice command stylus and the electronic touch sensitive device may be in communication with the cloud computing server. The cloud/network may be a public and/or private network, such as a private local area network (e.g., home cloud) operatively coupled to a wide area network such as the Internet. The communication link may be established over a wireless connection using, for example, Wi-Fi or cellular network (e.g., 3G/4G) technologies. In this example embodiment, the cloud computing server may be programmed or otherwise configured to receive and/or transmit data from/to a user via the voice command stylus or the electronic touch sensitive device, such as data relating to stylus voice command functionality as described herein. In some such embodiments, the server may be configured to remotely provision the stylus voice command functionality and/or the results of issued voice commands to the electronic touch sensitive device (e.g., via JavaScript or other browser based technology). In other embodiments, portions of the voice command functionality may be executed on the server and other portions of the voice command functionality are executed on the device. In some embodiments, the cloud computing server may be capable of determining and/or executing a desired function based on an issued voice command received from a voice command stylus. Numerous server-side/client-side execution schemes can be implemented to facilitate the stylus voice command functionality as variously described herein, as will be apparent in light of this disclosure.

Stylus Voice Command Functionality Examples

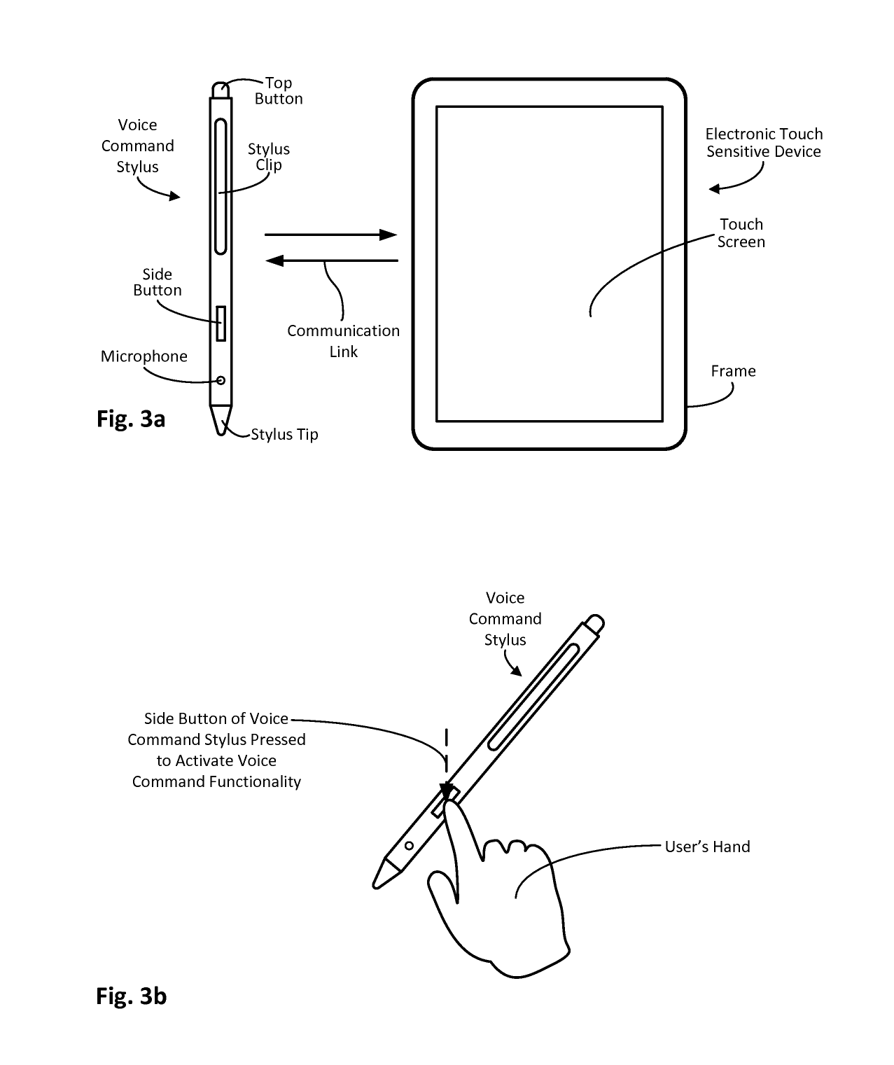

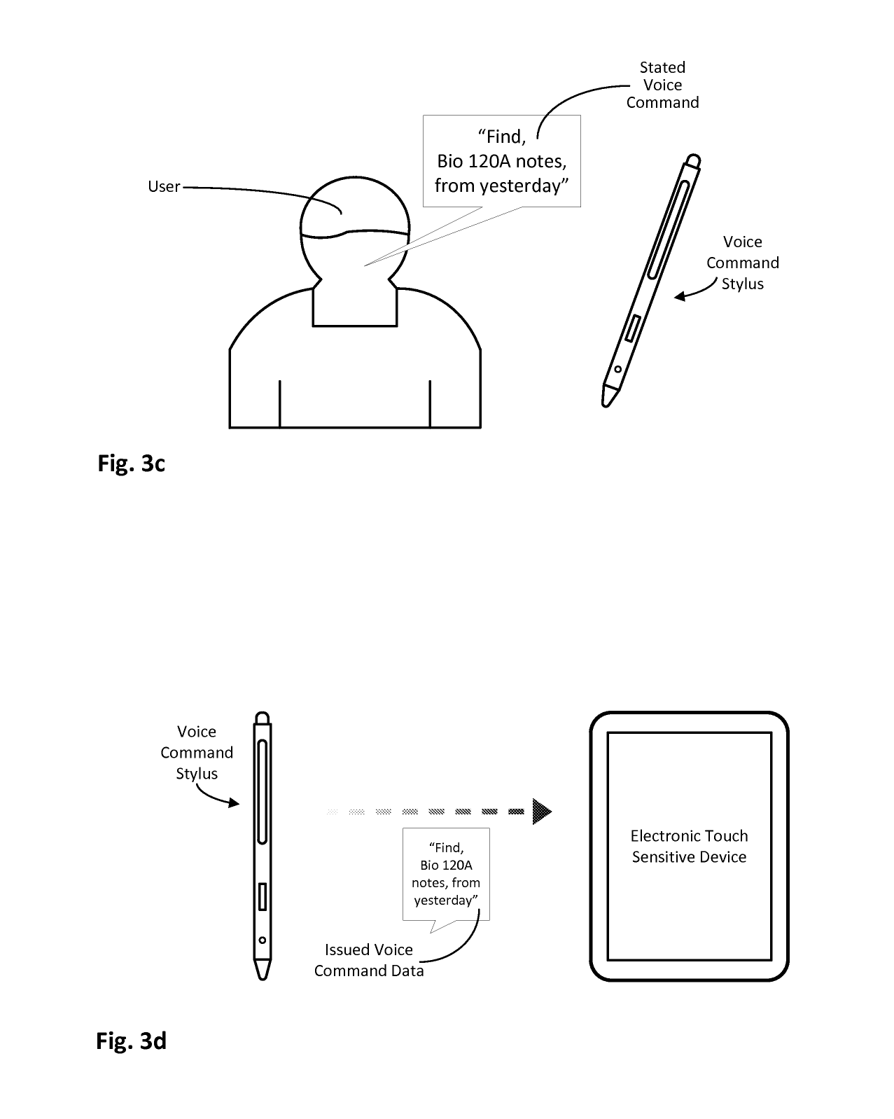

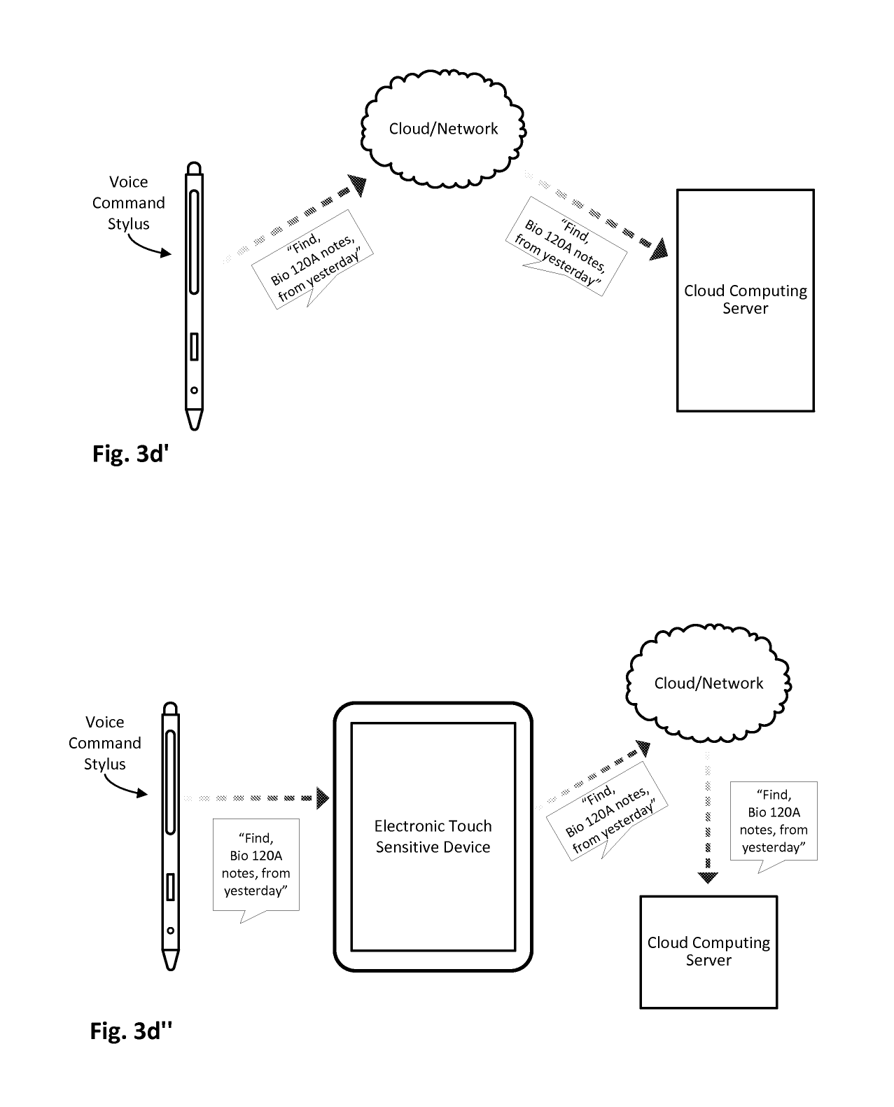

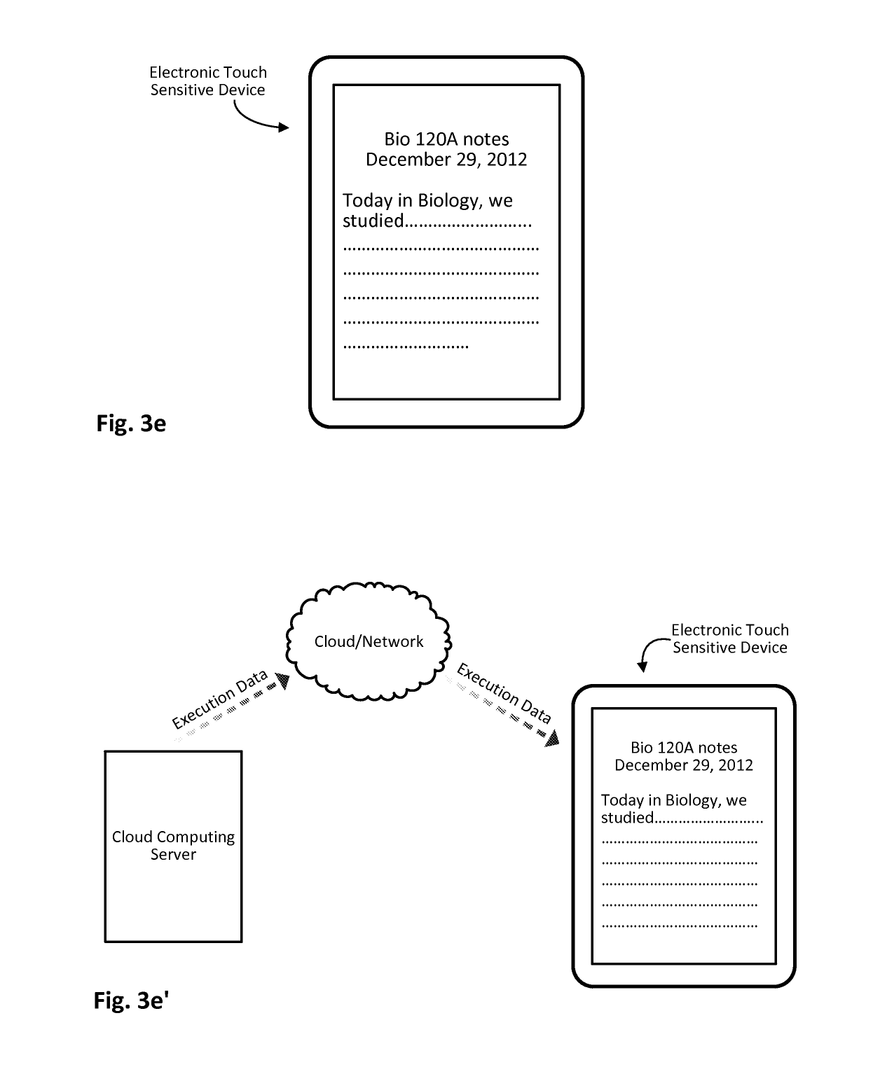

FIGS. 3a-e′ illustrate examples of activating a voice command from a stylus to initiate a search for user content, in accordance with one or more embodiments of the present invention. FIG. 3a shows a voice command stylus in communication with a related electronic touch sensitive device. The example voice command stylus provided is the same stylus shown in FIG. 1c and described herein. As previously described, this example voice command stylus includes a top button, side button, stylus clip, microphone, and stylus tip. The electronic touch sensitive device shown in FIG. 3a includes a physical frame or support structure provided about a touch screen. The electronic touch sensitive device, as used herein, may be a smart phone, eReader, tablet, or any other electronic touch sensitive device. In other embodiments, the display and touch sensitive interface of the electronic touch sensitive device may be separate, such as a non-touch sensitive display used with a track pad. The communication link, as used herein, may be established using conventional or custom discovery and handshake protocols as was previously described. The communication link may be Bluetooth-based or Wi-Fi-based, for example.

FIG. 3b shows a user performing an activation action to activate voice command functionality from the voice command stylus. In this specific embodiment, the user is pressing the side button of the stylus (using a finger of the user's hand) to activate voice command functionality. In such an embodiment, the microphone may be enabled or turned on in response to the activation action, e.g., in response to pressing the stylus side button. However, other suitable stylus control features and actions may be used to activate voice command functionality, such as pressing a different stylus button (e.g., the top button of the stylus), rotating a twistable knob, moving a sliding control feature, or shaking the stylus (e.g., where the stylus includes accelerometers and can detect shaking input), just to name a few more examples. In some embodiments, the stylus microphone may always be on such that voice commands can be issued to the stylus at any time. In some such embodiments, the user may have to get within a certain range of the microphone to issue a voice command or issue voice commands in a certain direction relative to the stylus (e.g., if the stylus has a unidirectional microphone).

FIG. 3c shows the user stating a voice command to the stylus after voice command functionality has been activated. In this specific example, the user is stating a command to initiate a search for user content. As shown, the specific stated voice command is “Find, Bio 120A notes, from yesterday.” Since stylus voice command functionality was activated before the voice command was issued by the user, the stylus microphone can receive the voice command and transmit it to a related electronic touch sensitive device or to a cloud computing server. FIGS. 3d-d″ show the issued voice command from FIG. 3c being transmitted from the voice command stylus to a related electronic touch sensitive device and/or to a cloud computing server. More specifically, FIG. 3d shows the voice command being directly transmitted to a related electronic touch sensitive device; FIG. 3d′ shows the voice command being directly transmitted to the cloud computing server; and FIG. 3d″ shows the voice command being indirectly transmitted to the cloud computing server through the related electronic touch sensitive device. Dashed arrows are provided in the figures for illustrative purposes to indicate the direction of travel for voice commands and/or other data.

After the issued voice command has been transmitted to the related electronic touch sensitive device and/or to the cloud computing server, a desired function may be determined and/or executed based on the voice command. In this specific example, the voice command was used to find, or initiate a search for, user content relating to Bio 120A notes, from yesterday. FIG. 3e shows the results after the desired function was determined and/or executed based on the voice command. More specifically, the result of the voice command in this example caused the desired function of displaying the Bio 120A notes from yesterday (from Dec. 29, 2012, in this example) on the related electronic touch sensitive device. In this manner, a voice activated stylus can be used to find various types of content, such as notes, eBooks, videos, music, etc. As previously described, determining and/or executing a desired function based on a received voice command may include voice command software (e.g., Google Now, Apple's Siri, or Samsung's S Voice) or other suitable conventional or customary technology, such as various speech recognition software, intelligent/virtual personal assistant software, or knowledge navigator software, just to name a few technologies.

FIG. 3e′ shows an alternative example method of achieving the same result shown in FIG. 3e. In the example shown in FIG. 3e′, the cloud computing server determined the desired function based on the voice command stated in FIG. 3c and caused the function to be executed on the related electronic touch sensitive device. The server caused the function to be executed by sending (or pushing) execution data related to the desired function to the electronic touch sensitive device, which caused the Bio 120A notes from yesterday (Dec. 29, 2012, in this example) to be displayed on the device as shown.

After the Bio 120A notes have been found based on the first issued voice command and displayed on the related electronic touch sensitive device (as shown in FIGS. 3e and 3e′), the user can then activate voice command functionality from the stylus and issue additional voice commands related to the open content, if desired. In this manner, the user can issue one or more additional voice commands to, for example, search within the Bio 120A notes. In another example, a user could issue a voice command search “Open Campbell's Biology” or “Find Campbell's Biology” to cause Campbell's Biology eBook to be opened on a related electronic touch sensitive device. In such an example, once Campbell's Biology eBook has been opened, the user can issue a second voice command to perform a search within the Biology eBook, such as “Search for mitosis.” After issuing the second voice command to search for mitosis within the Biology eBook, the results of the search may be displayed on the related electronic touch sensitive device.

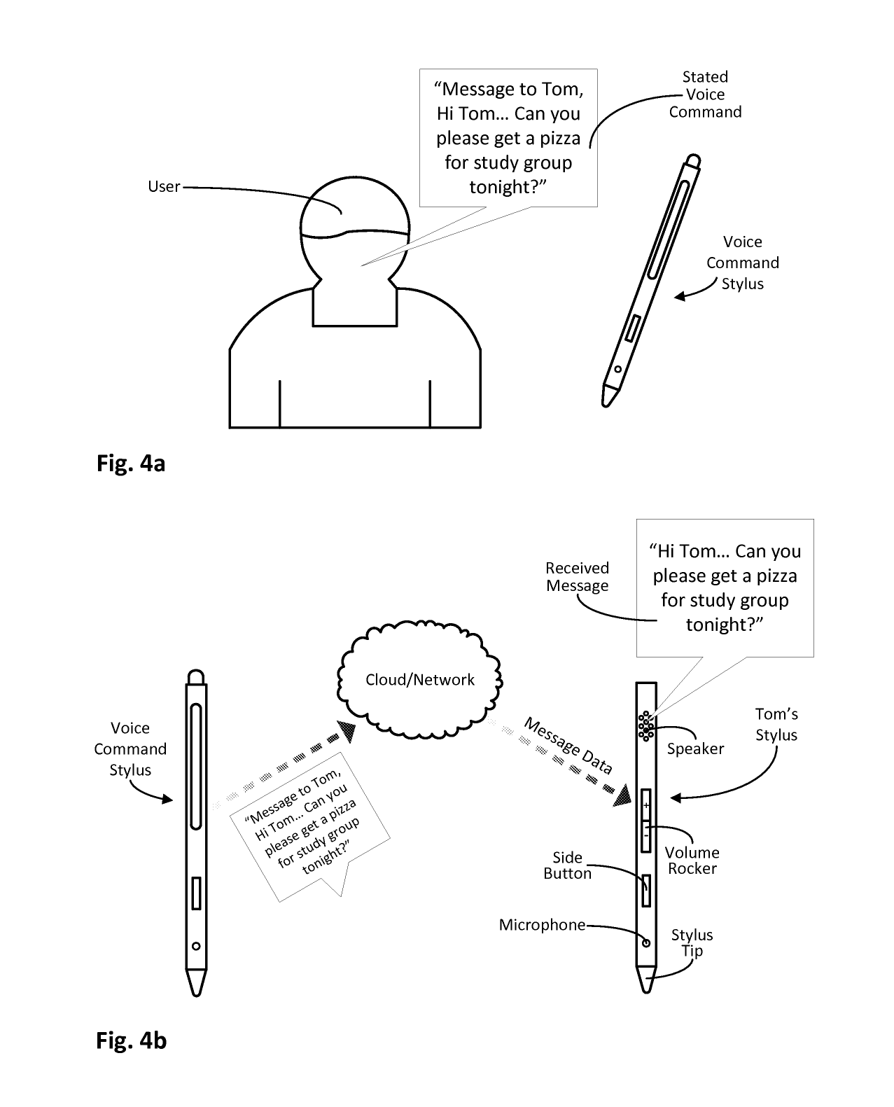

FIGS. 4a-b illustrate an example of activating a voice command from a stylus to send a message to another device, in accordance with an embodiment of the present invention. FIG. 4a starts off after stylus voice command functionality has been activated (e.g., as shown in FIG. 3b). The user in this example states a voice command to the stylus to cause a message to be sent to another device. As shown, the specific stated voice command is “Message to Tom, Ho Tom . . . . Can you please get a pizza for study group tonight?” The stylus microphone receives the voice command and then transmits it to the cloud computing server, in this example. The cloud computing server can then determine and/or execute a desired function based on the voice command. In this example, the cloud computing server determines that the voice command is associated with the desired function of sending a message (based on the first portion of the voice command—“Message to Tom”) and then sends the message (based on the second portion of the voice command “Hi Tom . . . . Can you please get a pizza for study group tonight?”) to the unrelated device (Tom's stylus). In one such example case, a look-up table is consulted that associates the name “Tom” with a communication ID, such as a transceiver ID associated with Tom's computing device or stylus. After the message data is sent, Tom's stylus plays the message as shown in FIG. 4b. For purposes of completeness, Tom's stylus includes a speaker for producing sounds (e.g., for playing the received message), a volume rocker for changing the speaker volume, a side button, a microphone, and a stylus tip. Numerous variations and configurations will be apparent in light of this disclosure.

Methodology

FIG. 5 illustrates a method for implementing stylus voice command functionality, in accordance with one or more embodiments of the present invention. The stylus having voice command functionality is intended to interact with a related touch sensitive device, as previously described. The related device may be a smart phone, eReader, tablet, or any other suitable electronic touch sensitive device. As previously described, the voice command stylus includes at least one control feature that can be used to activate voice command functionality and at least one microphone for receiving stated voice commands from a user. As can be seen, in this example case, the method starts by determining 501 whether the stylus voice command functionality has been activated. Example activation actions may include pressing a side button on the stylus, pressing a top button on the stylus, shaking the stylus (e.g., if the stylus includes an accelerometer for detecting shaking input), or other suitable actions depending upon the control features included on the voice command stylus. In some instances, the stylus microphone may always be on such that voice commands can be issued to the stylus at any time. In some such instances, the user may have to get within a certain range of the microphone to issue a voice command or issue voice commands in a certain direction relative to the stylus (e.g., if the stylus has a unidirectional microphone). If the stylus voice command functionality has not been activated, the method continues by waiting until the stylus voice command functionality is activated.

Once the stylus voice command functionality has been activated, the method continues by determining 502 if the stylus is configured to provide feedback when voice command functionality is activated. If the stylus is configured to provide feedback, the method continues by providing 503 such feedback to indicate that voice command functionality has been activated. Example feedback may include visual feedback (e.g., a stylus status LED lights up or changes to a specific color, such as green), auditory feedback (e.g., a stylus speaker beeps or plays “please state a command”), and/or tactile feedback (e.g., a stylus vibrating motor vibrates or other haptic feedback is provided). Regardless of whether the stylus is configured to provide feedback to indicate that voice command functionality has been activated, the method continues by determining 504 if the stylus microphone has received a voice command. In other words, the method continues by determining 504 if a voice command has been stated by a user.

If a voice command has not been received by the stylus microphone, the method continues by determining 505 if voice command functionality has been cancelled. In some instances, cancellation events may be passive, such as cancelling voice command functionality when a period of time has elapsed where no voice command has been received. In other instances, cancellation events may be active, such as providing a cancellation action or input. In some such instances, the same action used to activate voice command functionality from the stylus may also be used to cancel voice command functionality. For example, if the voice command stylus is configured to activate voice command functionality in response to pressing a side button on the stylus, pressing the side button again may cancel voice command functionality. If voice command functionality has been cancelled, then the method continues by returning 506 to the beginning of the method, i.e., it returns to determining 501 if stylus voice command functionality has been activated. If the voice command functionality has not been cancelled, the method continues to review until either the stylus microphone has received a voice command or voice command functionality has been cancelled.

Once the stylus microphone receives a voice command after voice command functionality has been activated, the method continues by transmitting 507 the voice command to a related touch sensitive device and/or to a remote system (e.g., a cloud computing server). The stylus communication module can be used to send the voice command and the transmission may be made via a Bluetooth, Wi-Fi, or cellular network connection, or some other suitable wireless technology. After the voice command is transmitted, the method continues by determining 508 a desired function based on the issued voice command. The desired function may be determined using voice command software, for example. Once the desired function is determined, the method continues by executing 509 the desired function. As previously described, the voice commands and corresponding desired functions may include initiating searches for user content, initiating searches for content on the web, sending voice messages, sending voice to text messages (e.g., where the voice message is translated to a text message), initiating calls, controlling media playback, creating calendar events, or navigating the user interface of a related electronic touch sensitive device, just to name a few examples.

As previously described, the intelligence (e.g., the processor(s)/controller(s), memory, software, etc.) for determining and/or executing desired functions based on issued voice commands may be located in the stylus itself, in a related touch sensitive computing device, in a remote system, or some combination thereof. To this end, the stylus voice command functionality for determining and/or executing desired functions based on issued voice commands can be implemented in any combination of software, hardware, and firmware distributed amongst the three entities (i.e., the voice command stylus, the related device, and the remote system). In one specific embodiment, the UI module of the electronic touch sensitive device is configured to determine and/or execute a desired function based on an issued voice command received from a related stylus. In another specific embodiment, the remote system (e.g., a cloud computing server) is configured to determine and/or execute a desired function based on an issued voice command received from a voice command stylus. However, as will be appreciated, once the voice command is transmitted from the stylus to a related device and/or to the remote system, determining and/or executing a desired function based on the voice command may be distributed in nature, wherein some is performed by the related device and some by the remote system, for instance. In still other embodiments, the voice command stylus may determine and/or execute a desired function based on an issued voice command.

Numerous variations and embodiments will be apparent in light of this disclosure. One example embodiment of the present invention provides a stylus including an elongated body portion having a stylus tip for interacting with an electronic touch sensitive interface, a control feature for activating voice command functionality, a microphone for receiving a voice command after voice command functionality has been activated, and a communication module for transmitting the received voice command to one of an electronic touch sensitive device and a cloud computing server, wherein the voice command initiates a desired function executed by one of the touch sensitive computing device and the cloud computing server. In some cases, the stylus tip is designed to interact with a capacitive touch screen. In some cases, the communication module transmits the voice command via a Bluetooth connection. In some cases, wherein the communication module transmits the voice command via a Wi-Fi connection. In some cases, the communication module transmits the voice command via a cellular network connection. In some cases, the desired function initiates a search for user content and the results of the search are displayed on the electronic touch sensitive device. In some cases, the desired function sends a message to another device based on a voice message contained within the voice command. In some cases, a communication system includes the stylus and an electronic touch sensitive device. In some such cases, the electronic touch sensitive device includes a display for displaying content to a user and a touch sensitive interface for allowing user input, a communication module for receiving a voice command transmitted from the stylus, and voice command software capable of executing a desired function based on the received voice command. In some cases, a communication system includes the stylus and a cloud computing server. In some such cases, the cloud computing server includes a communication module for receiving a voice command transmitted from the stylus, and voice command software capable of executing a desired function based on the received voice command.

Another example embodiment of the present invention provides a server including a processing module configured to execute one or more software applications, a communication module configured to receive a voice command from a stylus capable of interacting with an electronic touch sensitive interface, and a memory module including voice command software capable of determining and/or executing a desired function based on the received voice command. In some cases, the communication module receives the voice command via a Wi-Fi connection. In some cases, the communication module receives the voice command via a cellular network connection. In some cases, the desired function initiates a search for user content and the results of the search are displayed on an electronic touch sensitive device related to the stylus. In some cases, the desired function sends a message to another device based on a voice message contained within the voice command.

Another example embodiment of the present invention provides a computer program product including a plurality of instructions non-transiently encoded thereon to facilitate operation of an electronic device according to a process. The computer program product may include one or more computer readable mediums such as, for example, a hard drive, compact disk, memory stick, server, cache memory, register memory, random access memory, read only memory, flash memory, or any suitable non-transitory memory that is encoded with instructions that can be executed by one or more processors, or a plurality or combination of such memories. In this example embodiment, the process is configured to receive a voice command from a stylus capable of interacting with an electronic touch sensitive interface, determine a desired function based on the received voice command using voice command software, and cause the desired function to be executed. In some cases, the voice command is received via a Wi-Fi connection. In some cases, the voice command is received via a cellular network connection. In some cases, the desired function initiates a search for user content and the results of the search are displayed on an electronic touch sensitive device related to the stylus. In some cases, the desired function sends a message to another device based on a voice message contained within the voice command. In some cases, the electronic device configured to perform the process is a cloud computing server.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A stylus comprising:
an elongated body portion having a stylus tip for interacting with an electronic touch sensitive interface;
a control feature for activating voice command functionality;
a microphone for receiving a voice command after voice command functionality has been activated; and
a communication module for transmitting the received voice command to one of an electronic touch sensitive device and a cloud computing server, wherein the voice command initiates a desired function executed by one of the touch sensitive computing device and the cloud computing server.

2. The stylus of claim 1 wherein the stylus tip is designed to interact with a capacitive touch screen.

3. The stylus of claim 1 wherein the communication module transmits the voice command via a Bluetooth connection.

4. The stylus of claim 1 wherein the communication module transmits the voice command via a Wi-Fi connection.

5. The stylus of claim 1 wherein the communication module transmits the voice command via a cellular network connection.

6. The stylus of claim 1 wherein the desired function initiates a search for user content and the results of the search are displayed on the electronic touch sensitive device.

7. The stylus of claim 1 wherein the desired function sends a message to another device based on a voice message contained within the voice command.

8. A communication system comprising the stylus as defined in claim 1 and an electronic touch sensitive device, wherein the electronic touch sensitive device includes:
a display for displaying content to a user and a touch sensitive interface for allowing user input;
a communication module for receiving a voice command transmitted from the stylus; and
voice command software capable of executing a desired function based on the received voice command.

9. A communication system comprising the stylus as defined in claim 1 and a cloud computing server, wherein the cloud computing server includes:
a communication module for receiving a voice command transmitted from the stylus; and
voice command software capable of executing a desired function based on the received voice command.

10. A server comprising:
a processing module configured to execute one or more software applications;
a communication module configured to receive a voice command from a stylus capable of interacting with an electronic touch sensitive interface; and
a memory module including voice command software capable of determining and/or executing a desired function based on the received voice command.

11. The server of claim 10 wherein the communication module receives the voice command via a Wi-Fi connection.

12. The server of claim 10 wherein the communication module receives the voice command via a cellular network connection.

13. The server of claim 10 wherein the desired function initiates a search for user content and the results of the search are displayed on an electronic touch sensitive device related to the stylus.

14. The server of claim 10 wherein the desired function sends a message to another device based on a voice message contained within the voice command.

15. A computer program product comprising a plurality of instructions non-transiently encoded thereon to facilitate operation of an electronic device according to the following process:
receive a voice command from a stylus capable of interacting with an electronic touch sensitive interface;
determine a desired function based on the received voice command using voice command software; and
cause the desired function to be executed.

16. The computer program product of claim 15 wherein the voice command is received via a Wi-Fi connection.

17. The computer program product of claim 15 wherein the voice command is received via a cellular network connection.

18. The computer program product of claim 15 wherein the desired function initiates a search for user content and the results of the search are displayed on an electronic touch sensitive device related to the stylus.

19. The computer program product of claim 15 wherein the desired function sends a message to another device based on a voice message contained within the voice command.

20. The computer program product of claim 15 wherein the electronic device configured to perform the process is a cloud computing server.
